(19) United States
(12) Patent Application Publication
(10) Pub. No.: US 2024/0375701 A1
(43) Pub. Date: Nov. 14, 2024

(54) STEERING WHEEL CONSTRUCTION

(71) Applicant: Lubrizol Advanced Materials, Inc., Cleveland, OH (US)

(72) Inventors: Satyanarayana Nistala, Mentor, OH (US); Christopher Seifert, Mentor, OH (US); Zhiguan Yang, Broadview Hts., OH (US); Joseph J. Vontorcik, Jr., Broadview Hts., OH (US)

(73) Assignee: Lubrizol Advanced Materials, Inc., Cleveland, OH (US)

(21) Appl. No.: 18/692,399

(22) PCT Filed: Sep. 14, 2022
(86) PCT No.: PCT/US2022/043440

§ 371 Date: Mar. 15, 2024

Related U.S. Application Data
(60) Provisional application No. 63/244,778, filed on Sep. 16, 2021.

(51) Int. Cl. B62D 1/06; B29C 45/00; B29K 75/00; B29K 105/04; B29L 31/30

(52) U.S. Cl. CPC B62D 1/06; B29C 45/0001; B29K 2075/00; B29K 2105/04; B29L 2031/3047

(57) ABSTRACT

A steering wheel for a vehicle is provided which comprises a steering wheel rim, a hub base and at least one spoke, wherein the hub base is arranged inside the steering wheel rim and the hub base is connected to the steering wheel rim by the at least one spoke. The steering wheel is formed from a rigid, injection molded thermoplastic polyurethane material.

### SUMMARY OF THE INVENTION

The present invention provides a steering wheel for a vehicle, which comprises a steering wheel frame, wherein the steering wheel frame comprises a first thermoplastic polyurethane material has (a) a weight average molecular weight (Mw) of 50,000 to 350,000 Daltons, or 80,000 to 200,000 Daltons; (b) a Notched Izod Impact Strength (3.2 mm/23° C.) of 1.5 to 30 ft-lb/in, or 15 to 30 ft-lb/in measured according to ASTM D256; (c) a flexural modulus of 80,000 to 2,300,000 or 150,000 to 500,000 measured according to ASTM D790; (d) Instrumented Dart Impact (Total Energy at 23° C.) of 100-900 in-lb measured according to ASTM D 3763; and (e) Tensile Modulus of 80,000 to 2,600,000 psi, or 100,000 to 300,000 psi measured according to ASTM D638. The present invention also includes a method of making the steering wheel frame by injection molding the first thermoplastic polyurethane composition to form the steering wheel frame.

In another embodiment, the steering wheel frame also includes a foam cover, wherein the foam cover comprises a flexible injection molded thermoplastic polyurethane foam, wherein the flexible injection molded thermoplastic polyurethane foam is formed from the combination of (i) a second thermoplastic polyurethane material, wherein the second thermoplastic polyurethane material has a weight average molecular weight of 50,000 to 350,000 Daltons or 100,000 to 200,000 Daltons as measured by gel permeation chromatography and a dispersity (Mw/Mn) of 1.2 to 3.5 or 2.0 to 2.5 and (ii) and a chemical blowing agent and/or a cell opening surfactant. The present invention also provides a method for partially or completely covering the steering wheel frame with a foam cover by injection molding a foaming mixture comprising the combination of the second thermoplastic polyurethane material and a blowing agent as described herein.

### BRIEF DESCRIPTION OF THE DRAWINGS

FIG. 1 shows a schematic representation of a steering wheel.

### DETAILED DESCRIPTION OF THE INVENTION

The present invention provides a steering wheel for a vehicle. In one exemplary embodiment, the steering wheel comprises a steering wheel rim, a hub base, and at least one spoke, wherein the hub base is arranged inside the steering wheel rim and the hub based is connected to the rim by at least one spoke.

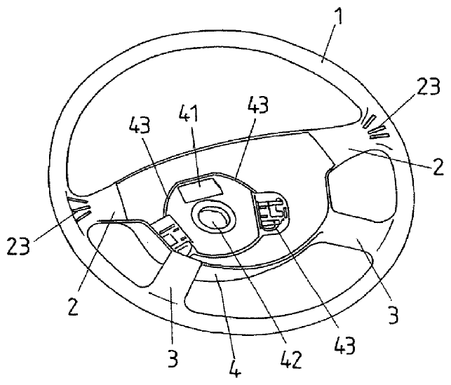

FIG. 1 illustrates an example of a steering wheel frame construction in accordance with an embodiment of the present invention. In this exemplary embodiment, the steering wheel frame is made up of a steering wheel rim 1, two side spokes 2, one central spoke 3, and a hub base 4. In this exemplary embodiment, the side spokes 2 and the central spoke 3 connect the steering wheel rim 1 to the hub base 4. The hub base 4 has a bottom surface 40 into which one or more recesses 41, 42 are incorporated. In one embodiment, one of the recesses, for example recess 42 may serve for receiving a steering shaft of the vehicle in which the steering wheel is employed.

In one embodiment, the hub base 4 is shaped so that further vehicle components, such as, for example, an airbag module, may be inserted into the hub base. Such further components may be incorporated by any known or hereafter discovered means in the art.

While FIG. 1 illustrates an example of a steering wheel frame embodiment that may be included within the scope of the invention, it should be appreciated that the steering wheel frame may have any type of configuration as may be now known or hereafter developed in the art, with the only proviso being that the steering wheel frame is made from the thermoplastic polyurethane material as set forth herein. For example, constructions of steering wheels are illustrated in US2010/0018343, U.S. Pat. No. 5,445,048, GB2061848, WO2002006108, and WO2008025546, which are hereby incorporated herein by reference.

In one embodiment, the steering wheel of the present invention also includes a foam cover on the steering wheel frame. In the present invention, the foam cover is made of a thermoplastic polyurethane material as set forth herein.

In the present invention, the steering wheel frame is constructed from a thermoplastic polyurethane material. In some embodiments, the foam cover for the steering wheel frame also comprises a thermoplastic polyurethane material. The compositions of thermoplastic polyurethane materials will be described in more detail below.

Thermoplastic polyurethane (“TPU”) compositions useful in the present invention generally comprise the reaction product of a polyisocyanate component, a polyol component, and a chain extender component. These components will be described in more detail herein.

In some embodiments of the invention, the polyisocyanate component comprises one or more diisocyanates. Useful polyisocyanates may be selected from aromatic polyisocyanates or aliphatic polyisocyanates or combinations thereof. Examples of useful polyisocyanates include, but are not limited to aromatic diisocyanates such as 4,4′-methylenebis(phenyl isocyanate) (MDI), m-xylene diisocyanate (XDI), phenylene-1,4-diisocyanate, 3,3′-dimethyl-4,4′-biphenylene diisocyanate (TODI), 1,5-naphthalene diisocyanate (NDI), and toluene diisocyanate (TDI), as well as aliphatic diisocyanates such as isophorone diisocyanate (IPDI), 1,6-hexamethylene diisocyanate (HDI), 1,4-cyclohexyl diisocyanate (CHDI), decane-1,10-diisocyanate, lysine diisocyanate (LDI), 1,4-butane diisocyanate (BDI), and dicyclohexylmethane-4,4′-diisocyanate (H12MDI). In some embodiments, mixtures of two or more polyisocyanates may be used.

Thermoplastic polyurethane compositions used in the present invention are also made using a polyol component. Polyols may include polyether polyols, polyester polyols, polycarbonate polyols, polysiloxane polyols, and combinations thereof. In some embodiments polyol or components thereof are derived from biomass resources and in other embodiments the components are synthetic or derived from petroleum.

In one embodiment, the polyol component may be a polyester polyol. Polyester polyols useful in the present invention may be produced by (1) an esterification reaction of one or more glycols with one or more dicarboxylic acids or anhydrides or (2) by transesterification reaction, i.e., the reaction of one or more glycols with esters of dicarboxylic acids. Mole ratios generally in excess of more than one mole of glycol to acid are preferred so as to obtain linear chains having a preponderance of terminal hydroxyl groups. Suitable polyester intermediates also include various lactones such as polycaprolactone typically made from 8-caprolactone and a bifunctional initiator such as diethylene glycol. The dicarboxylic acids of the desired polyester can be aliphatic, cycloaliphatic, aromatic, or combinations thereof. In some embodiments, dicarboxylic acids which may be used alone or in mixtures generally have a total of from 4 to 15 carbon atoms and include: succinic, glutaric, adipic, pimelic, suberic, azelaic, sebacic, dodecanedioic, isophthalic, terephthalic, cyclohexane dicarboxylic, and the like. Anhydrides of the above dicarboxylic acids such as phthalic anhydride, tetrahydrophthalic anhydride, or the like, can also be used. The glycols which are reacted to form a desirable polyester intermediate can be aliphatic, aromatic, or combinations thereof, including any of the glycols described above in the chain extender section, and have a total of from 2 to 20 or from 2 to 12 carbon atoms. Suitable examples include ethylene glycol, 1,2-propanediol, 1,3-propanediol, 1,3-butanediol, 1,4-butanediol, 1,5-pentanediol, 1,6-hexanediol, 2,2-dimethyl-1,3-propanediol, 1,4-cyclohexanedimethanol, decamethylene glycol, dodecamethylene glycol, and mixtures thereof.

The polyester polyol component may also include one or more polycaprolactone polyester polyols. The polycaprolactone polyester polyols useful in the technology described herein include polyester diols derived from caprolactone monomers. The polycaprolactone polyester polyols are terminated by primary hydroxyl groups. Suitable polycaprolactone polyester polyols may be made from ¿-caprolactone and a bifunctional initiator such as diethylene glycol, 1,4-butanediol, or any of the other glycols and/or diols listed herein. In some embodiments, the polycaprolactone polyester polyols are linear polyester diols derived from caprolactone monomers.

Useful examples include CAPA™ 2202A, a 2,000 number average molecular weight (Mn) linear polyester diol, and CAPA™ 2302A, a 3,000 Mn linear polyester diol, both of which are commercially available from Perstorp Polyols Inc. These materials may also be described as polymers of 2-oxepanone and 1,4-butanediol.

The polycaprolactone polyester polyols may be prepared from 2-oxepanone and a diol, where the diol may be 1,4-butanediol, diethylene glycol, monoethylene glycol, 1,6-hexanediol, 2,2-dimethyl-1,3-propanediol, or any combination thereof. In some embodiments, the diol used to prepare the polycaprolactone polyester polyol is linear. In some embodiments, the polycaprolactone polyester polyol is prepared from 1,4-butanediol. In some embodiments, the polycaprolactone polyester polyol has a number average molecular weight from 500 to 10,000, or from 500 to 5,000, or from 1,000 or even 2,000 to 4,000 or even 3,000.

In one embodiment, the polyol component may be a polyether polyol. Suitable polyether polyol intermediates include polyether polyols derived from a diol or polyol having a total of from 2 to 15 carbon atoms, in some embodiments an alkyl diol or glycol which is reacted with an ether comprising an alkylene oxide having from 2 to 6 carbon atoms, typically ethylene oxide or propylene oxide or mixtures thereof. For example, hydroxyl functional polyether can be produced by first reacting propylene glycol with propylene oxide followed by subsequent reaction with ethylene oxide. Primary hydroxyl groups resulting from ethylene oxide are more reactive than secondary hydroxyl groups and thus are preferred. Useful commercial polyether polyols include poly(ethylene glycol) comprising ethylene oxide reacted with ethylene glycol, poly(propylene glycol) comprising propylene oxide reacted with propylene glycol, poly(tetramethylene ether glycol) comprising water reacted with tetrahydrofuran which can also be described as polymerized tetrahydrofuran, and which is commonly referred to as PTMEG. In some embodiments, the polyether intermediate includes PTMEG. Suitable polyether polyols also include polyamide adducts of an alkylene oxide and can include, for example, ethylenediamine adduct comprising the reaction product of ethylenediamine and propylene oxide, diethylenetriamine adduct comprising the reaction product of diethylenetriamine with propylene oxide, and similar polyamide type polyether polyols. Copolyethers can also be utilized in the described compositions. Typical copolyethers include the reaction product of THF and ethylene oxide or THF and propylene oxide. These are available from BASF as PolyTHF® B, a block copolymer, and PolyTHF® R, a random copolymer. The various polyether intermediates generally have a number average molecular weight (Mn) as determined by assay of the terminal functional groups which is an average molecular weight greater than about 700, such as from about 700 to about 10,000, from about 1,000 to about 5,000, or from about 1,000 to about 2,500. In some embodiments, the polyether intermediate includes a blend of two or more different molecular weight polyethers, such as a blend of 2,000 Mn and 1,000 Mn PTMEG.

In another embodiment, the polyol component may be a polycarbonate polyol. Suitable polycarbonate polyols include those prepared by reacting a glycol with a carbonate. U.S. Pat. No. 4,131,731 is hereby incorporated by reference for its disclosure of hydroxyl terminated polycarbonates and their preparation. Such polycarbonates are linear and have terminal hydroxyl groups with essential exclusion of other terminal groups. The essential reactants are glycols and carbonates. Suitable glycols are selected from cycloaliphatic and aliphatic diols containing 4 to 40, and or even 4 to 12 carbon atoms, and from polyoxyalkylene glycols containing 2 to 20 alkoxy groups per molecule with each alkoxy group containing 2 to 4 carbon atoms. Suitable diols include aliphatic diols containing 4 to 12 carbon atoms such as 1,4-butanediol, 1,5-pentanediol, neopentyl glycol, 1,6-hexanediol, 2,2,4-trimethyl-1,6-hexanediol, 1,10-decanediol, hydrogenated dilinoleylglycol, hydrogenated dioleylglycol, 3-methyl-1,5-pentanediol; and cycloaliphatic diols such as 1,3-cyclohexanediol, 1,4-dimethylolcyclohexane, 1,4-cyclohexanediol-, 1,3-dimethylolcyclohexane-, 1,4-endomethylene-2-hydroxy-5-hydroxymethyl cyclohexane, and polyalkylene glycols. The diols used in the reaction may be a single diol or a mixture of diols depending on the properties desired in the finished product. Polycarbonate intermediates which are hydroxyl terminated are generally those known to the art and in the literature. Suitable carbonates are selected from alkylene carbonates composed of a 5 to 7 member ring. Suitable carbonates for use herein include ethylene carbonate, trimethylene carbonate, tetramethylene carbonate, 1,2-propylene carbonate, 1,2-butylene carbonate, 2,3-butylene carbonate, 1,2-ethylene carbonate, 1,3-pentylene carbonate, 1,4-pentylene carbonate, 2,3-pentylene carbonate, and 2,4-pentylene carbonate. Also, suitable herein are dialkylcarbonates, cycloaliphatic carbonates, and diarylcarbonates. The dialkylcarbonates can contain 2 to 5 carbon atoms in each alkyl group and specific examples thereof are diethylcarbonate and dipropylcarbonate. Cycloaliphatic carbonates, especially dicycloaliphatic carbonates, can contain 4 to 7 carbon atoms in each cyclic structure, and there can be one or two of such structures. When one group is cycloaliphatic, the other can be either alkyl or aryl. On the other hand, if one group is aryl, the other can be alkyl or cycloaliphatic. Examples of suitable diarylcarbonates, which can contain 6 to 20 carbon atoms in each aryl group, are diphenylcarbonate, ditolylcarbonate, and dinaphthylcarbonate.

In one embodiment, the polyol component may comprise a polysiloxane polyol. Suitable polysiloxane polyols include α-ω-hydroxyl or amine or carboxylic acid or thiol or epoxy terminated polysiloxanes. Examples include poly(dimethysiloxane) terminated with a hydroxyl or amine or carboxylic acid or thiol or epoxy group. In some embodiments, the polysiloxane polyols are hydroxyl terminated polysiloxanes. In some embodiments, the polysiloxane polyols have a number-average molecular weight in the range from 300 to 5,000, or from 400 to 3,000.

Polysiloxane polyols may be obtained by the dehydrogenation reaction between a polysiloxane hydride and an aliphatic polyhydric alcohol or polyoxyalkylene alcohol to introduce the alcoholic hydroxy groups onto the polysiloxane backbone.

In some embodiments, the polysiloxanes may be represented by one or more compounds having the following formula:

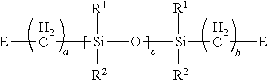

in which: each R1 and R2 are independently a 1 to 4 carbon atom alkyl group, a benzyl, or a phenyl group; each E is OH or NHR³ where R³ is hydrogen, a 1 to 6 carbon atoms alkyl group, or a 5 to 8 carbon atoms cyclo-alkyl group; a and b are each independently an integer from 2 to 8; c is an integer from 3 to 50. In amino-containing polysiloxanes, at least one of the E groups is NHR³. In the hydroxyl-containing polysiloxanes, at least one of the E groups is OH. In some embodiments, both R¹ and R² are methyl groups.

Suitable examples include α,ω-hydroxypropyl terminated poly(dimethysiloxane) and α,ω-amino propyl terminated poly(dimethysiloxane), both of which are commercially available materials. Further examples include copolymers of the poly(dimethysiloxane) materials with a poly(alkylene oxide).

The thermoplastic polyurethane compositions described herein will typically be made using a chain extender component. Chain extenders include may include diols, diamines, and combination thereof.

Suitable chain extenders include relatively small polyhydroxy compounds, for example lower aliphatic or short chain glycols having from 2 to 20, or 2 to 12, or 2 to 10 carbon atoms. Suitable examples include ethylene glycol, diethylene glycol, propylene glycol, dipropylene glycol, 1,4-butanediol (BDO), 1,6-hexanediol (HDO), 1,3-propanediol, 1,5-pentanediol, neopentylglycol, 1,4-cyclohexanedimethanol (CHDM), 2,2-bis[4-(2-hydroxyethoxy) phenyl]propane (HEPP), hydroquinone bis(2-hydroxyethyl) ether (HQEE), hexamethylenediol, heptanediol, nonanediol, dodecanediol, 3-methyl-1,5-pentanediol, ethylenediamine, butanediamine, hexamethylenediamine, and hydroxyethyl resorcinol (HER), and the like, as well as mixtures thereof.

Optional additive components may be present during the polymerization reaction, and/or incorporated into the TPU composition described above to improve processing and other properties. These additives include but are not limited to antioxidants, organic phosphites, phosphines and phosphonites, hindered amines, organic amines, organo sulfur compounds, lactones and hydroxylamine compounds, biocides, fungicides, antimicrobial agents, compatibilizers, electro-dissipative or anti-static additives, fillers and reinforcing agents, such as titanium dioxide, alumina, clay and carbon black, flame retardants, such as phosphates, halogenated materials, and metal salts of alkyl benzenesulfonates, impact modifiers, such as methacrylate-butadiene-styrene (“MBS”) and methylmethacrylate butylacrylate (“MBA”), mold release agents such as waxes, fats and oils, pigments and colorants, plasticizers, polymers, rheology modifiers such as monoamines, polyamide waxes, silicones, and polysiloxanes, slip additives, such as paraffinic waxes, hydrocarbon polyolefins and/or fluorinated polyolefins, and UV stabilizers, which may be of the hindered amine light stabilizers (HALS) and/or UV light absorber (UVA) types. Other additives may be used to enhance the performance of the TPU compostion or blended product. All of the additives described above may be used in an effective amount customary for these substances.

These additional additives can be incorporated into the components of, or into the reaction mixture for, the preparation of the TPU composition, or after making the TPU composition. In another process, all the materials can be mixed with the TPU composition and then melted or they can be incorporated directly into the melt of the TPU composition.

In some embodiments, the additives may include fillers or reinforcing agents. Fillers include a wide range of particulate materials, including talc, marble, granite, carbon black, graphite, aramid, silica-alumina, zirconia, bentonite, antimony trioxide, coal-based fly ash, clay, feldspar, nepheline, fumed silica, alumina, magnesium oxide, zinc oxide, barium sulfate, aluminum silicate, calcium silicate, titanium dioxide, titanates, chalk, milled glass, silica or glass, glass microspheres, glass beads or glass fibers. The glass fibers used may be made from E, A or C glass and have preferably been provided with a size and with a coupling agent. Their diameter is generally from 6 to 20 μm. Use may be made either of continuous-filament fibers (rovings) or of chopped glass fibers (staple) whose length is from 1 to 10 mm, preferably from 3 to 6 mm.

The fillers may also be metal hydroxides, e.g., magnesium hydroxide, potassium hydroxide and aluminum trihydroxide; metal carbonates such as magnesium carbonate and calcium carbonate; metal sulfides and sulfates such as molybdenum disulfide and barium sulfate; metal borates such as barium borate, meta-barium borate, zinc borate and meta-zinc borate; metal anhydride such as aluminum anhydride; or aluminum trihydrate.

Boron nitride and various reclaimed and reground thermoset polyurethane and/or polyurea polymers may also be used.

Representative fillers include but are not limited to clay such as diatomite, kaolin and montmorillonite; huntite; celite; asbestos; ground minerals; and lithopone. These fillers are typically used a conventional manner and in conventional amounts, e.g., from 5 wt % or less to 50 wt % or more based on the weight of the composition.

Reinforcements include high aspect ratio materials such as platelets and fibers, which can be of glass, aramid, various other polymers, and the like. Additional materials which may be used include mineral fibers, whiskers, alumina fibers, mica, powdered quartz, metal fibers, carbon fibers and wollastonite. Reinforcing agents, are usually used in amounts of from 5 to 50% by weight, based on the entire layer or composition.

Fillers which are useful in some formulations include ignition resistance fillers which can include antimony oxide, decabromobiphenyl oxide, alumina trihydrate, magnesium hydroxide, borates, and halogenated compounds.

Other miscellaneous fillers include wood fibers/flours/chips, rubber dust, cotton, starch, clay, synthetic fibers (e.g., polyolefin fibers), and carbon fibers.

The level of the filler depends upon the filler density; the higher the filler density, the more of it which can be added to the formulation without appreciably affecting the volume fraction of that filler. Accordingly, the level of the filler is discussed herein in terms of weight percent filler, based on the total formulation weight. In the formulations disclosed herein, the filler content ranges from about 0.1% to about 80%, preferably from about 5% to about 50% (except for carbon black, which is typically used at levels from about 0.1% to about 5%), more preferably from about 5% to about 40%, and especially from about 8% to about 30%.

In another embodiment, the additives may include flame retardant additives. The flame retardants may be, but not necessarily, intumescent. Examples include phenylbisdodecyl phosphate, phenylbisneopentyl phosphate, phenyl ethylene hydrogen phosphate, phenyl-bis-3,5,5′-trimethylhexyl phosphate), ethyldiphenyl phosphate, 2-ethylhexyl di(p-tolyl) phosphate, diphenyl hydrogen phosphate, bis(2-ethyl-hexyl) ptolylphosphate, tritolyl phosphate, bis(2-ethylhexyl)-phenyl phosphate, tri (nonylphenyl) phosphate, phenylmethyl hydrogen phosphate di(dodecyl) p-tolyl phosphate, tricresyl phosphate, triphenyl phosphate, dibutylphenyl phosphate, p-tolyl bis(2,5,5′-trimethylhexyl) phosphate, 2-ethylhexyldiphenyl phosphate, and diphenyl hydrogen phosphate. The preferred flame retardants are bisphenol-A bis(diphenyl phosphate), resorcinol bis(diphenyl phosphate), and cresol bis(diphenyl phosphate).

Further examples of flame retardants include a brominated organic compound, for example, a brominated diol. It may contain from 5 to 20 carbon atoms, and in some embodiments 5 to 10, or even 5 carbon atoms, and may contain a quaternary carbon atom. The additive may be present in an amount sufficient to provide the desired flame retardancy, and in other embodiments may be present from 0 to 15 percent by weight of the overall composition, or even from 0 to 10, from 0.1 to 7, or from 0.2 to 5 percent by weight of the overall composition.

Further examples include brominated organic compounds. Suitable examples include brominated diols, brominated mono-alcohols, bromimated ethers, brominated esters, brominated phosphates, and combinations thereof. Suitable brominated organic compounds may include tetrabromobisphenol-A, hexabromocyclododecane, poly(pentabromobenzyl acrylate), pentabromobenzyl acrylate, tetrabromobisphenol A-bis(2,3-dibromopropyl ether), tribromophenol, dibromoneopentyl glycol, tribromoneopentyl alcohol, tris(tribromoneopentyl) phosphate, and 4,4′-isopropylidenebis[2-(2,6-dibromophenoxy) ethanol].

In some embodiments, the flame retardant additive includes a metal salt of a halogen borate, metal salt of halogen phosphate, or a combination thereof. In some embodiments, combinations of retardants are used. Additional examples of flame retardant additives include a metal salt of organic sulfonate, for example, a sodium salt of an alkyl benzene sulfonate and in some embodiments, the flame retardant additive includes a nitrogen-containing compound.

In some embodiments, the additives may include impact modifiers. An impact modifier may be added to the TPU compositions described above and are added in an effective amount to improve the impact resistance and especially the low temperature toughness of the polyurethane. By improvement of low temperature toughness, it is meant that the Izod impact strength at −30° C. can be improved according to ASTM D256. Another improvement is that melt processability is improved such that the shear viscosity of the polyurethane is reduced as a result of a lowering of the melt processing temperature and further that this reduction is achieved without causing a non-cohesive external skin to form on a heat formed product.

In an embodiment, the impact modifier contains both a rubbery component and a grafted rigid phase component. Preferred impact modifiers are prepared by grafting a (meth)acrylate and/or vinyl aromatic polymer, including copolymers thereof such as styrene/acrylonitrile, onto the selected rubber. In an embodiment, the graft polymer is a homo- or copolymer of methylmethacrylate. The rubber material can be, for example, one or more of the well-known butadiene-, butyl acrylate-, or EPDM-types. In various embodiments, the impact modifier will contain at least about 40 weight percent of the rubber material, or at least about 45 and in another at least about 60 weight percent of the rubber material. The impact modifier can contain up to 100 weight percent rubber (no rigid phase) and in an embodiment contains less than 95 weight percent of the rubber material, and in another embodiment less than 90 weight percent of the rubber material with the balance being a rigid phase polymer of which at least a significant portion is graft polymerized and/or crosslinked around or to the rubber material.

Examples of impact modifiers include but are not limited to methacrylatebutadiene-styrene (“MBS”) rubbers such as Paraloid EXL 3607 and methylmethacrylate butylacrylate (“MBA”) rubbers such as Paraloid 3300 which rubbers generally contain 45-90 weight percent elastomer.

Another impact modifier which may be used contains as rubber material a substrate polymer latex or core which is made by polymerizing a conjugated diene, or by copolymerizing a conjugated diene with a mono-olefin or polar vinyl compound, such as styrene, acrylonitrile or methyl methacrylate. The substrate rubber is typically made up of about 45 to 100 percent conjugated diene and up to about 55 percent of the mono-olefin or polar vinyl compound. A mixture of monomers is then graft polymerized to the substrate latex. A variety of monomers may be used for this grafting purpose, including vinyl aromatic compounds such as styrene, vinyl toluene, α-methyl styrene, halogenated styrene, naphthalene; acrylonitriles including methacrylonitrile or α-halogenated acrylonitrile; or a C1-C8 alkyl (meth)acrylate such as methyl acrylate, ethylacrylate, hexyl acrylate, methyl methacrylate, ethyl methacrylate or hexyl methacrylate; an acrylic or methacrylic acid; or a mixture of two or more of the foregoing. The extent of grafting is sensitive to the substrate latex particle size and grafting reaction conditions, and particle size may be influenced by controlled coagulation techniques among other methods. The rigid phase may be crosslinked during the polymerization by incorporation of various polyvinyl monomers such as divinyl benzene and the like.

The impact modifier (from EP 0353673 B1) may be a carbonyl modified polyolefin. More specifically, it is a graft copolymer containing a polyolefin backbone with pendant carbonyl containing compounds. Based upon the entire weight of the graft copolymer, the amount of the polyolefin is from 90 percent to 99.9 percent, desirably from 93 percent to 98 percent, and preferably from 95 to 98 percent by weight. Suitable graft copolymers may have a melt index of from 1 to 20; in another embodiment from 1 to 10; and in yet another embodiment from 1 to 5.

The polyolefin component of the impact modifier (i.e. graft copolymer) is a homopolymer or a copolymer made from one or more monomers having from 2 to 6 carbon atoms; and desirably 2 or 3 carbon atoms. Specific examples of suitable polyolefins include the homopolymer of ethylene, propylene, or isobutylene, copolymers of propylene and ethylene, and of ethylene-propylene-diene monomers with the diene having from 4 to 8 carbon atoms. Suitable ethylene polymers for modification include high density polyethylene, low density polyethylene, and linear low density polyethylene. When a copolymer is utilized, the amount of the ethylene monomer utilized and hence the amount of the ethylene repeating unit in the copolymer can vary considerably as from 1 percent to 50 percent, in other cases from 3 percent to 25 percent, with approximately 10 percent being yet another embodiment.

In one embodiment, the impact modifier includes from 0.1 to 10 percent, in another embodiment from 0.2 to 7 percent, and in still another embodiment from 0.2 to 6 percent by weight of a carbonyl compound selected from, fumaric acid, maleic acid, or maleic anhydride.

The impact modifiers may be used in a range of 1 to 30 parts, and in some embodiments from 1 to 20, and in other embodiments from 5 to 15 parts by weight per 100 parts by weight of the polyurethane. The impact modifiers of the present invention are particularly useful when added to polyurethane blends which include a reinforcing agent and/or a filler. In the past, when a reinforcing agent has been added to polyurethane, the impact resistance, especially at low temperatures or at room temperature, has been poor as has been the melt processability of the resultant composite. Thus, the impact modifiers of the present invention are useful with reinforced polyurethanes to improve impact resistance, melt processability and to produce polyurethane composites having improved dimensional stability. By improved dimensional stability an improvement in one or more of the following characteristics is meant: flexural modulus, flexural strength, tensile yield strength and heat distortion temperature. When used with reinforced polyurethanes, the amount of the impact modifier can be the same as the amount used for unreinforced polyurethanes.

In some embodiments, the additives may include one or more plasticizers. The type of plasticizer used can be any of the known plasticizers for use in TPU. The most common plasticizer types used are phthalates with butyl benzyl phthalate being the most preferred. Plasticizers used in the present invention can include phthalate based plasticizers, such as, di-n-butylphthalate, di-2-ethylhexyl phthalate (DOP), di-n-octyl phthalate, diisodecyl phthalate, diisooctyl phthalate, octyldecyl phthalate, butylbenzyl phthalate, and di-2-ethyhexyl phosphate isophthalate; aliphatic ester-based plasticizers, such as di-2-ethylhexyl adipate (DOA), di-n-decyl adipate, diisodecyl adipate, dibutyl sebacate, and di-2-ethylhexyl sebacate; pyrometallitate-based plasticizers, such as trioctyl trimellitate and tridecyl trimellitate; phosphate-based plasticizers, such as tributyl phosphate, tri-2-ethylhexyl phosphate, 2-ethylhexyldiphenyl phosphate, and tricresyl phosphate; epoxy-based plasticizers, such as epoxy-based soybean oil; and polyesterbased polymer plasticizers. For applications that are sensitive from the toxicological point of view, such as children's toys and food contact, di-isononyl-cyclohexane-1,2-dicarboxylate (Hexamoll® DINCH® from BASF) may be used as the plasticizer. A single plasticizer may be used or a combination of two or more plasticizers may be used. The selection of the desired plasticizer will depend on the end use application of the TPU polymer, as is well understood by those skilled in the art of formulating TPU.

The described compositions include the TPU materials described above and also TPU compositions that include such TPU materials and one or more additional components. These additional components include other polymeric materials that may be blended with the TPU described herein. These additional components include one or more additives that may be added to the TPU, or blend containing the TPU, to impact the properties of the composition.

The TPU described herein may also be blended with one or more other polymers. The polymers with which the TPU described herein may be blended are not overly limited. In some embodiments, the described compositions include two or more of the described TPU materials. In some embodiments, the compositions include at least one of the described TPU materials and at least one other polymer, which is not one of the described TPU materials.

Polymers that may be used in combination with the TPU materials described herein also include more conventional TPU materials such as non-caprolactone polyester-based TPU, polyether-based TPU, or TPU containing both non-caprolactone polyester and polyether groups. Other suitable materials that may be blended with the TPU materials described herein include polycarbonates, polyolefins, styrenic polymers, acrylic polymers, polyoxymethylene polymers, polyamides, polyphenylene oxides, polyphenylene sulfides, polyvinylchlorides, chlorinated polyvinylchlorides, polylactic acids, or combinations thereof.

Polymers for use in the blends described herein include homopolymers and copolymers. Suitable examples include: (i) a polyolefin (PO), such as polyethylene (PE), polypropylene (PP), polybutene, ethylene propylene rubber (EPR), polyoxyethylene (POE), cyclic olefin copolymer (COC), or combinations thereof; (ii) a styrenic, such as polystyrene (PS), acrylonitrile butadiene styrene (ABS), styrene acrylonitrile (SAN), styrene butadiene rubber (SBR or HIPS), poly-α-methylstyrene, styrene maleic anhydride (SMA), styrene-butadiene copolymer (SBC) (such as styrene-butadiene-styrene copolymer (SBS) and styrene-ethylene/butadiene-styrene copolymer (SEBS)), styreneethylene/propylene-styrene copolymer (SEPS), styrene butadiene latex (SBL), SAN modified with ethylene propylene diene monomer (EPDM) and/or acrylic elastomers (for example, PS-SBR copolymers), or combinations thereof; (iii) a thermoplastic polyurethane (TPU) other than those described above; (iv) a polyamide, such as Nylon™, including polyamide 6,6 (PA66), polyamide 1,1 (PA11), polyamide 1,2 (PA12), a copolyamide (COPA), or combinations thereof; (v) an acrylic polymer, such as polymethyl acrylate, polymethylmethacrylate, a methyl methacrylate styrene (MS) copolymer, or combinations thereof; (vi) a polyvinylchloride (PVC), a chlorinated polyvinylchloride (CPVC), or combinations thereof; (vii) a polyoxyemethylene, such as polyacetal; (viii) a polyester, such as polyethylene terephthalate (PET), polybutylene terephthalate (PBT), copolyesters and/or polyester elastomers (COPE) including polyether-ester block copolymers such as glycol modified polyethylene terephthalate (PETG), polylactic acid (PLA), polyglycolic acid (PGA), copolymers of PLA and PGA, or combinations thereof; (ix) a polycarbonate (PC), a polyphenylene sulfide (PPS), a polyphenylene oxide (PPO), or combinations thereof; or combinations thereof.

In some embodiments, the TPU composition may include a UV stabilizer additive. Such additives may be especially useful in applications in which transparency is wanted or in which the part will be exposed to sunlight or other sources of ultraviolet radiation. Suitable UV light stabilizers include hindered amine light stabilizers (HALS) and UV light absorber (UVA) additives. Blends of HAL and UVA additives are also effective.

Representative HALS that can be used in the practice of this invention include, but are not limited to, Sterically hindered amines as well as the N derivatives thereof (e.g., N-alkyl, N-hydroxy, N-alkoxy and N-acyl), such as bis(2,2,6,6-tetramethylpiperidin-4-yl) sebacate; bis(2,2,6,6tetramethylpiperidin-4-yl) succinate; bis(1,2,2,6,6-pentamethylpiperidin-4-yl) sebacate; bis(1-octyloxy-2,2,6,6-tetramethylpiperidin-4-yl) sebacate; bis(1,2,2,6,6-pentamethylpiperidin-4-yl) n-butyl 3,5-di-tert-butyl-4-hydroxybenzylmalonate; the condensate of 1 (2-hydroxyethyl)-2,2,6,6-tetramethyl-4-hydroxypiperidine and succinic acid; the condensate of N,N′-bis(2,2,6,6-tetramethylpiperidin-4-yl) hexamethylenediamine and 4-tert-octylamino-2,6-dichloro-1,3,5-triazine; tris(2,2,6,6-tetramethylpiperidin-4-yl) nitrilotriacetate; tetrakis(2,2,6,6-tetramethylpiperidin-4y1)-1,2,3,4-butanetetracarboxylate; 1,1′-(1,2ethanediyl)bis(3,3,5,5-tetramethylpiperazinone); 4-benzoyl-2,2,6,6-tetramethylpiperidine; 4-stearyloxy-2,2,6,6-tetramethylpiperidine; bis(1,2,2,6,6-pentamethylpiperidyl)-2-n-butyl-2-(2-hydroxy-3,5-di-tert-butylbenzyl) malonate; 3-n-octyl-7,7,9,9-tetramethyl-1,3,8-triazaspiro[4.5]decan-2,4-dione; bis(1-octyloxy-2,2,6,6-tetramethylpiperidyl) sebacate; bis(1-octyloxy-2,2,6,6-tetramethylpiperidyl) succinate; the condensate of N,N′-bis(2,2,6,6-tetramethylpiperidin4-yl) hexamethylenediamine and 4-morpholino-2,6-dichloro1,3,5-triazine; the condensate of 2-chloro-4,6-bis(4-nbutylamino-2,2,6,6-tetramethylpiperidyl)-1,3,5-triazine and 1,2-bis(3-aminopropylamino) ethane; the condensate of 2-chloro-4,6-bis(4-n-butylamino-1,2,2,6,6-pentamethylpiperidyl)-1,3,5-triazine and 1,2-bis-(3aminopropylamino) ethane; 8-acetyl-3-dodecyl-7,7,9,9-tetramethyl-1,3,8-triazaspiro[4.5]decane-2,4-dione; 3-dodecyl-1-(2,2,6,6-tetramethylpiperidin-4-yl) pyrrolidin-2,5-dione; 3-dodecyl-1-(1-ethanoyl-2,2,6,6tetramethylpiperidin-4-yl) pyrrolidin-2,5-dione; 3-dodecyl-1-(1,2,2,6,6-pentamethylpiperidin-4yl) pyrrolidine-2,5-dione; a mixture of 4-hexadecyloxyand 4-stearyloxy-2,2,6,6-tetramethylpiperidine; the condensate of N,N′-bis(2,2,6,6-tetramethylpiperidin-4yl) hexamethylenediamine and 4-cyclohexylamino-2,6-dichloro-1,3,5-triazine; the condensate of 1,2-bis(3-aminopropylamino) ethane, 2,4,6-trichloro-1,3,5-triazine and 4-butylamino-2,2,6,6-tetramethylpiperidine, 2-undecyl-7,7,9,9-tetramethyl-1-oxa-3,8-diaza-4-oxospiro[4.5]decane; oxo-piperanzinyl-triazines and similar materials disclosed in U.S. Pat. No. 5,071,981; photobondable HALS and similar materials disclosed in GB-A-2269819; and the reaction product of 7,7,9,9-tetramethyl-2-cycloundecyl-1-oxa-3,8-diaza-4oxospiro[4.5]decane and epichlorohydrin. See also generally U.S. Pat. Nos. 4,619,956, 5,106,891, GB-A-2269819, EP-A0309400, EP-A-0309401, EP-A-0309402 and EP-A-0434608. Some commercially available examples of HALS additives are Tinuvin® 123, Tinuvin 123-DW, Tinuvin 144, Tinuvin 152, Tinuvin 292, Tinuvin 622-SF, Tinuvin 770-DF, Tinuvin 5100 (the Tinuvin® series of additives are available from BASF), Chimassorb® 119, Chimassorb 2020 (the Chimassorb® series of additives are available from BASF), Lowilite® 76, Lowilite 62 (the Lowilite® series of additives are available from Addivant), Uvinul® 4050FF (BASF), LA-52, LA-576, LA-63P, 68, 72, 77Y, 77G, 81, 82, 87, 4042F, 502XP (the LA series of additives are available from Adeka Corporation), Hostavin® N30, Hostavin N845PP, Hostavin 3050, Hostavin 3051, Hostavin 3052, Hostavin 3053, Hostavin 3055, Hostavin 3058, Hostavin 3065, Hostavin PR-31 (the Hostavin® series of additives are available from Clariant), and Nylostab® S-EED® (available from Clariant), Additional preferred hindered amine light stabilizer may be listed in the Plastics Additives Handbook 6th Edition, Hans Zweifel, Ralph Maier, Michael Schiller (Hanser Publications, Inc., Cincinnati, Ohio, USA, 2009). If present, then the HALS is typically present in an amount of greater than 0 to 4, more typically of 0.2 to 3 and even more typically of 0.5 to 2, wt % based on the weight of the composition.

Without being bound by theory, typically a UV stabilizer works by scavenging the free radicals and/or hydroperoxides formed by UV light damage while a UV absorber works by absorbing and dissipation the UV radiation. Suitable UV absorbers include, but are not limited to, triazines, benzoxazinones, benzotriazoles, benzophenones, benzoates, formamidines, cinnamates/propenoates, aromatic propanediones, benzimidazoles, cycloaliphatic ketones, formanilides (including oxamides), cyanoacrylates, benzopyranones, salicylates, and mixtures of two or more of these.

Suitable benzophenone UV absorbers include, but are not limited to, 2-hydroxy-4-methoxybenzophenone, 2-hydroxy-4-methoxy-5-sulfobenzophenone or sulisobenzone, 2-(4-benzoyl-3-hydroxyphenoxy)-2-propenoic acid ethyl ester, homopolymer of 4-(2-acryloyloxyethoxy)-2-hydroxybenzophenone, 2,2′-dihydroxy-4-methoxybenzophenone or dioxybenzone, 2-hydroxy-4-(2-hydroxy-3-decyloxypropoxy) benzophenone and 2-hydroxy-4-(2-hydroxy-3-octyloxypropoxy) benzophenone, 2,4,4′-trihydroxybenzophenone, 2-hydroxy-4-(isooctyloxy) benzophenone, 2-hydroxy-4-dodecyloxybenzophenone, 2,2′-dihydroxy-4,4′-dimethoxy-5,5′-disulfobenzophenone, disodium salt, 2,4-dihydroxybenzophenone or 4-benzoylresorcinol, 2,2′-dihydroxy-4,4′-dimethoxybenzophenone, 2,2′,4,4′-tetrahydroxybenzophenone, 2,2′-dihydroxy-4-(2-hydroxyethoxy) benzophenone, 2-hydroxy-4-benzyloxybenzophenone, and mixtures of two or more of these. MAXGARDR 300, MAXGARD® 400, MAXGARD® 500, MAXGARDR 600, MAXGARDR 700, MAXGARDR 900, MAXGARD® 1000 MAXGARD® 1800, (The Maxgard series of chemicals can be obtained from Syrgis Performance Specialties)

Suitable benzopyranone UV absorbers include, but are not limited to, 3,3′,4′,5,7-pentahydroxyflavone or quercetin.

Suitable benzotriazole UV absorbers include, but are not limited to, 2-[2-hydroxy-5-(1,1,3,3-tetramethylbutyl) phenyl]benzotriazole, 2-(2′-hydroxy-5′-(2-hydroxyethyl)) benzotriazole, 2-(2′-hydroxy-5′-methacrylyloxyethylphenyl)-2H-benzotriazole, 1,1,1-tris(hydroxyphenyl) ethane benzotriazole, 5-t-butyl-3-(5-chloro-2H-benzotriazol-2-yl)-4-hydroxybenzenepropanoic acid octyl ester and 3-(5-chloro-2H-benzotriazol-2-yl)-5-t-butyl-4-hydroxybenzenepropanoic acid octyl ester, α-[3-[3-(2H-benzotriazol-2-yl)-5-t-butyl-4-hydroxyphenyl]-1-oxopropyl]-@-hydroxy poly(oxy-1,2-ethanediyl) and α-[3-[3-(2H-benzotriazol-2-yl)-5-t-butyl-4-hydroxyphenyl]-1-oxopropyl]-w-[3-[3-(2Hbenzotriazol-2-yl)-5-t-butyl-4-hydroxyphenyl]-1-oxopropoxy]poly(oxy-1,2-ethanediyl), 2-(2-Hydroxy-3,5-di-t-butylphenyl) benzotriazole, 2-(2-hydroxy-3-t-butyl-5-methylphenyl)-5-chloro-2H-benzotriazole, 2-(3′-5′-di-t-butyl-2′-hydroxyphenyl)-5-chlorobenzotriazole, 2-(2-Hydroxy-3,5-di-t-amylphenyl) benzotriazole, 3-(2H-benzotriazol-2-yl)-5-t-butyl-4-hydroxybenzenepropanoic acid, 2-(2H-benzotriazol-2-yl)-4-methyl-6-dodecylphenol, 3-(2H-benzotriazol-2-yl)-5-t-butyl-4-hydroxy-1,6-hexanediyl ester of benzenepropanoic acid and 3-(2H-benzotriazol-2-yl)-5-t-butyl-4-hydroxy-methyl ester of benzenepropanoic acid, 2-[2-hydroxy-3,5-bis-(1,1-dimethylbenzyl) phenyl]-2H-benzotriazole, 2-(2H-benzotriazol-2-yl)-6-(1-methyl-1-phenylethyl)-4-(1,1,3,3-tetramethylbutyl) phenol, 3-(2H-benzotriazol-2-yl)-5-t-butyl-4-hydroxybenzenepropanoic acid, C7-9 branched and linear alkyl esters, 2-(2-hydroxy-5-methylphenyl) benzotriazole, 2-(2′-hydroxy-3′-sec-butyl-5′-t-butylphenyl) benzotriazole, 2-(2′-hydroxy-5′-t-butylphenyl) benzotriazole, bis[2-hydroxy-3-(2H-benzotriazol-2-yl)-5-octylphenyl]methane, and mixtures of two or more of these. Some commercially avaialable examples of suitable benzotriazole UV absorbers include, but are not limited to TINUVIN® 99, TINUVIN 109, TINUVIN 328, TINUVIN 350, TINUVIN 360 TINUVIN 384-2, TINUVIN 571, TINUVIN 1130, and TINUVIN P. (The Tinuvin series of additives are available from BASF).

Suitable benzoate UV absorbers include, but are not limited to, hexadecyl 3,5-dit-butyl-4-hydroxybenzoate, 3-hydroxyphenylbenzoate, ethyl-4-[[(ethylphenylamino) methylene]amino]benzoate, phenyl 2-hydroxybenzoate or phenylsalicylate, 2,4-di-t-butylphenyl-3,5-di-t-butyl-4-hydroxybenzoate, 4-bis(polyethoxy) amino acid polyethoxy ethyl ester, 4-t-butylphenyl 2-hydroxybenzoate or 4-t-butylphenylsalicylate, and mixtures of two or more of these. Some commercially available examples of suitable UV absorbers of this type include, but are not limited to SEESORB 300; SEESORB 201; SEESORB 202 (The SEESORB UV absorbers are available from Shipro Kasei Kaisha, Ltd.); TINUVIN 120 (available from BASF); UVINUL® P 25 (available from BASF).

Suitable benzoxazinone UV absorbers include, but are not limited to, 2,2′-(pphenylene) di-3,1-benzoxazin-4-one. A commercially available example of a suitable UV absorbers of this type includes, but is not limited to CYASORB 3638 (from Cytec Industries Inc.).

Suitable cinnamates or propenoate UV absorbers include, but are not limited to, dimethyl(p-methoxybenzylidene) malonate, and 3-(4-methoxyphenyl)-2-propenoic acid 2-ethylhexyl ester or octyl p-methoxycinnamate.

Suitable cyanoacrylate UV absorbers include, but are not limited to, ethyl-2-cyano-3,3-diphenylacrylate,; 2-ethylhexyl-2-cyano-3,3-diphenylacrylate, 1,3-bis-[(2′-cyano-3,3′-diphenylacryloyl)oxy]-2,2-bis-{[(2-cyano-3′,3′-diphenylacryloyl)oxy]methyl}propane, and 2-cyano-3-(2-methylindolinyl) methylacrylate, Some commercially available examples of suitable UV absorbers of this type include, but are not limited to UVINUL® 3030, UVINUL 3035, and UVINUL 3039. The Uvinul series of additives are available from BASF.

Suitable cycloaliphatic ketone UV absorbers include, but are not limited to, 3-(4-methylbenzylidene)-D,L-camphor.

Suitable formamidine UV absorbers include, but are not limited to, ethyl-4-[[(methylphenylamino)methylene]amino]benzoate.

Suitable formanilide (including oxamide) UV absorbers include, but are not limited to, N-(2-ethoxyphenyl)-N′-(4-isododecylphenyl) oxamide, N-[5-t-Butyl-2-ethoxyphenyl)-N′-(2-ethylphenyl) oxamide, N-(2-ethoxyphenyl)-N′-(2-ethylphenyl) oxamide, 2H-benzimidazole-2-carboxylic acid (4-ethoxyphenyl) amide, and mixtures of two or more of these. Some commercially avaialable examples of these types of additives are Hostavin® 3206 from Clariant and TINUVIN® 312 from BASF;

Suitable triazine UV absorbers include, but are not limited to, 2-[4,6-bis(2,4-dimethylphenyl)-1,3,5-triazin-2-yl]-5-octyloxyphenol, 2-(4,6-diphenyl-1,3,5-triazin-2-yl)-5-hexyloxyphenol, 2-[4-((2-Hydroxy-3-dodecyloxy-propyl)oxy)-2-hydroxy2,4,6-Trianilino-p-(carbo-2′-phenyl]-4,6-bis(2,4-dimethylphenyl)-1,3,5-triazine, ethylhexyl-1′-oxy)-1,3,5-triazine, and mixtures of two or more of these. TINUVIN® 400; TINUVIN 1577 ED; UVINUL T-150 from BASF

Suitable salicylate UV absorbers include, but are not limited to, 3,3,5-trimethylcyclohexylsalicylate or homomethyl salicylate, and menthyl-o-aminobenzoate. Some commercially available examples of these types of additives are NEO HELIOPAN® HMS and NEO HELIOPAN® MA available from Symrise AG.

If present, then the UV absorber is typically present in an amount of greater than 0 to 4, more typically of 0.2 to 3 and even more typically of 0.3 to 2 wt % based on the weight of the composition.

In one non-limiting example of the present invention, the steering wheel frame is constructed of a thermoplastic polyurethane material. As an example of this embodiment, the invention may comprise a steering wheel for a vehicle which comprises a steering wheel frame comprising a steering wheel rim, a hub base and at least one spoke, wherein the hub base is arranged inside the steering wheel rim and the hub base is connected to the steering wheel rim by the at least one spoke and wherein the steering wheel frame is constructed from a thermoplastic polyurethane composition having a weight average molecular weight (Mw) of 50,000 to 350,000 Daltons, or 80,000 to 200,000 Daltons and has the following properties: (a) a Notched Izod Impact Strength (3.2 mm/23° C.) of 1.5 to 30 ft-lb/in, or even 15 to 30 ft-lb/in measured according to ASTM D256; (b) a flexural modulus of 80,000 to 2,300,000 or even 150,000 to 500,000 as measured according to ASTM D790; (c) Instrumented Dart Impact (Total Energy at 23° C.) of 100-900 in-lb measured according to ASTM D 3763; and (d) Tensile Modulus of 80,000 to 2,600,000 psi, or even 100,000 to 300,000 psi measured according to ASTM D638. In one embodiment, the thermoplastic polyurethane composition used to construct the steering wheel frame comprises the reaction product of a diisocyanate component, a chain extender component, and optionally, a polyol component. In one embodiment, the diisocyanate component is an aromatic diisocyanate, such as 4,4′-methylenebis(phenyl isocyanate). In one embodiment, the chain extender component may be selected from 1,4-butanediol, 1,6-hexanediol, 1,4-cyclohexanedimethanol, nonanediol, dodecanediol, or combinations thereof. In one embodiment the polyol component may be selected from polyether polyols and/or polyester polyols. In one embodiment, the thermoplastic polyurethane composition used to construct the steering wheel frame has a hard segment content (total weight percent of the isocyanate component and chain extender component) of at least 60% by weight or even 75% to 90% by weight.

The steering wheel of the present invention may, in some embodiments, also include a foam cover for the steering wheel frame, which at least partially or even completely covers the steering wheel frame. In some embodiments, the foam cover comprises a flexible injection molded thermoplastic polyurethane foam, wherein the flexible injection molded foam is formed from the combination of (a) a thermoplastic polyurethane composition having a (i) weight average molecular weight (Mw) of 50,000 to 350,000 Daltons, for example, 100,000 to 200,000 Daltons, or even 125,000 to 175,000, where Mw is measured by gel permeation chromatography and (ii) a dispersity (Mw/Mn) of 1.2 to 3.5, or even 2 to 2.5 and (b) a chemical blowing agent and/or a cell opening surfactant. In one embodiment, the flexible injection molded thermoplastic polyurethane foam has the following properties: (a) a peak temperature of crystallization of 25° C. to 205° C., or even 40° C. to 150° C. as measured by differential scanning chromatography (DSC); (b) a peak temperature of melting of 106° C. to 206° C. as measured by DSC; and (c) a difference between the peak temperature of melting and the peak temperature of crystallization of between 1 and 137 degrees. In another embodiment, the flexible injection molded thermoplastic polyurethane foam alternatively or additionally exhibits the following properties: (a) a vertical rebound of at least 30% measured according to ASTM D2632; (b) a compression set at room temperature of no more than 25% measured according to ASTM D395; (c) a compression set at 50° C. of no more than 50% measured according to ASTM D395; and (d) an Asker C hardness of 30 to 65 measured according to ASTM D2240. The chemical blowing agent used to make the thermoplastic polyurethane foam useful herein may be selected from exothermic type blowing agents or endothermic type blowing agents. One example of an exothermic type blowing agent is azodicarbonamide. An example of an endothermic type blowing agent is a mixture of sodium bicarbonate and citric acid. Mixtures of exothermic and endothermic type blowing agents may also be used. Any known or hereafter developed chemical blowing agents which release gas upon heating may be useful in the present invention. In some embodiments, the blowing agent may be added to the thermoplastic polyurethane composition in the form of a masterbatch which contains a polymer carrier, such as polyethylene or a thermoplastic polyurethane material (which may be the same or different from the thermoplastic polyurethane used for the foam) along with the chemical blowing agent. In embodiments where a masterbatch is used, the masterbatch is added in an amount of 0.5% to 10% by weight, for example 1% to 5% by weight (based on the total weight of the thermoplastic polyurethane composition and the masterbatch). In other embodiments, the thermoplastic polyurethane composition is foamed by the use of a cell opening surfactant. Examples of cell opening surfactants include, but are not limited to silicones, siloxane copolymers, non-siloxane copolymers, non-silicones, or any combination thereof. In addition to the chemical blowing agent, in some embodiments of the invention, the mixture for forming the foam may additionally include a physical blowing agent or a nucleating agent. Physical blowing agents include, but are not limited to linear, branched or cyclic C1 to C6 hydrocarbons, linear branched or cyclic C1 to C6 fluorocarbons; N₂, O₂, argon, CO₂, or any combination thereof. Nucleating agents may be selected from talk or silica. Thermoplastic polyurethane compositions useful in making foams for this invention include the reaction product of at least one polyol component, at least one diisocyanate component, and at least one chain extender component. In exemplary embodiments, the polyol components may be selected from polyether polyols (such as polytetramethylene ether glycol), polyester polyols (such as butanediol adipate), or polycaprolactone polyols. In one embodiment, the chain extender used in the thermoplastic polyurethane composition for the foam may be selected from 1,4-butanediol, benzene glycol, or combinations thereof. In one embodiment, the thermoplastic polyurethane composition used to construct the steering wheel frame has a hard segment content (total weight percent of the isocyanate component and chain extender component) of 20% to 60% by weight, or even 20% to 40% by weight or even 25% to 35% by weight. Examples of thermoplastic polyurethane foams that may be useful in the present invention include those disclosed in U.S. Pat. No. 10,973,281 and US20170178181 which are hereby incorporated by reference.

The present invention also includes a method for making a steering wheel which comprises the steps of injection molding a thermoplastic polyurethane composition to form a steering wheel frame. For example, the method of making the steering wheel frame includes injection molding a thermoplastic polyurethane composition having one or more of the following: (1) a weight average molecular weight (Mw) of 50,000 to 350,000 Daltons, or 80,000 to 200,000 Daltons; (2) a Notched Izod Impact Strength (3.2 mm/23° C.) of 1.5 to 30 ft-lb/in, or even 15 to 30 ft-lb/in measured according to ASTM D256; (3) a flexural modulus of 80,000 to 2,300,000 or even 150,000 to 500,000 as measured according to ASTM D790; (4) Instrumented Dart Impact (Total Energy at 23° C.) of 100-900 in-lb measured according to ASTM D 3763; and (5) Tensile Modulus of 80,000 to 2,600,000 psi, or even 100,000 to 300,000 psi measured according to ASTM D638. In one embodiment, the thermoplastic polyurethane composition used to construct the steering wheel frame comprises the reaction product of a diisocyanate component, a chain extender component, and optionally, a polyol component, where the thermoplastic polyurethane composition used to form the steering wheel frame has a hard segment content (total weight percent of the isocyanate component and chain extender component) of at least 60% by weight or even 75% to 90% by weight.

In another embodiment, the present invention includes a method of making a foamed thermoplastic polyurethane cover for a steering wheel. Such method may comprise the steps of (A) providing a steering wheel frame, wherein the steering wheel frame comprises a steering wheel rim, a hub base and at least one spoke, wherein the hub base is arranged inside the steering wheel rim and the hub base is connected to the steering wheel rim by the at least one spoke, and (B) forming a foam cover for the steering wheel frame by (1) providing a flexible thermoplastic polyurethane foaming mixture comprising a thermoplastic polyurethane material and a chemical blowing agent, wherein the thermoplastic polyurethane material comprises the reaction product of (i) at least one polyol component, (ii) at least one diisocyanate component, and (iii) at least one chain extender component, and wherein the thermoplastic polyurethane (a) has a hard segment content of 20% to 60% by weight, or 20% to 40% by weight, or 25% to 35% by weight, (b) a weight average molecular weight of 50,000 to 350,000 Daltons or 100,000 to 200,000 Daltons as measured by gel permeation chromatography, and (c) a dispersity (Mw/Mn) of 1.2 to 3.5 or 2.0 to 2.5; (2) mixing the thermoplastic polyurethane material and the chemical blowing agent, resulting in a foaming mixture; and (3) injection molding the foaming mixture in such a way that the second thermoplastic polyurethane material and the chemical blowing agent surfactant interact to form a flexible injection molded thermoplastic polyurethane foam. In one embodiment, the step of injection molding the foaming mixture takes place in a closed mold. In another embodiment, the step of injection molding the foaming mixture includes directly molding the foam cover to the steering wheel frame.

The present invention also includes a method of making a steering wheel which comprises the steps of (1) forming a steering wheel frame as described herein by injection molding a first thermoplastic polyurethane material as described herein as useful for a steering wheel frame and (2) forming a foam cover for a steering wheel using a combination of a second thermoplastic polyurethane composition as described herein.

Each of the documents referred to above is incorporated herein by reference, including any prior applications, whether or not specifically listed above, from which priority is claimed. The mention of any document is not an admission that such document qualifies as prior art or constitutes general knowledge of the skilled person in any jurisdiction. Except in the Examples, or whether otherwise explicitly indicated, all numerical quantities in this description specifying amounts of materials, reaction conditions, molecular weights, number of carbon atoms, and the like are to be understood as modified by the word “about.” It is to be understood that the upper and lower amount, range, and ratio limits set forth herein may be independently combined. Similarly, the ranges and amounts for each element of the invention can be used together with ranges or amounts for any of the other elements.

As used herein, the transitional term “comprising,” which is synonymous with “including,” “containing,” or “characterized by,” is inclusive or open-ended and does not exclude additional, un-recited elements or method steps. However, in each recitation of “comprising” herein, it is intended that the term also encompass, as alternative embodiments, the phrases “consisting essentially of” and “consisting of,” where “consisting of” excludes any element or step not specified and “consisting essentially of” permits the inclusion of additional un-recited elements or steps that do not materially affect the basic and novel characteristics of the composition or method under consideration.

While certain representative embodiments and details have been shown for the purpose of illustrating the subject invention, it will be apparent to those skilled in this art that various changes and modifications can be made therein without departing from the scope of the subject invention. In this regard, the scope of the invention is to be limited only by the following claims

1. A steering wheel for a vehicle comprising:
a steering wheel frame, wherein the steering wheel frame comprises a first thermoplastic polyurethane material having (a) a weight average molecular weight of 50,000 to 350,000 Daltons; (b) a Notched Izod Impact Strength (3.2 mm/23° C.) of 1.5 to 30 ft-lb/in measured according to ASTM D256; (c) a flexural modulus of 80,000 to 2,300,000 measured according to ASTM D790; (d) Instrumented Dart Impact (Total Energy at 23° C.) of 100-900 in-lb measured according to ASTM D 3763; and (e) Tensile Modulus of 80,000 to 2,600,000 psi measured according to ASTM D638.

2. The steering wheel of claim 1, wherein the first thermoplastic polyurethane material comprises the reaction product of a first diisocyanate component, a first chain extender component, and, optionally, at least one first polyol component, wherein the combined weight of the first diisocyanate component and the first chain extender component make up a hard segment content of the first thermoplastic polyurethane material.

3. The steering wheel of claim 2, wherein the first thermoplastic polyurethane material comprises at least 60% by weight hard segment content.

4. (canceled)

5. The steering wheel of claim 2, wherein the first diisocyanate component is an aromatic diisocyanate.

6. The steering wheel of claim 2, wherein the first diisocyanate component is 4,4′-methylenebis(phenyl isocyanate).

7. The steering wheel of claim 2, wherein the first chain extender component is selected from 1,4-butanediol, 1,6-hexanediol, 1,4-cyclohexanedimethanol, nonanediol, dodecanediol, or combinations thereof.

8. The steering wheel of claim 2, wherein the first polyol component is present and comprises a polyether polyol or a polyester polyol.

9. The steering wheel of claim 1, further comprising:
a foam cover for the steering wheel frame, wherein the foam cover comprises flexible injection molded thermoplastic polyurethane foam, wherein the flexible injection molded thermoplastic polyurethane foam is formed from the combination of (i) a second thermoplastic polyurethane material, wherein the second thermoplastic polyurethane material has a weight average molecular weight of 50,000 to 350,000 Daltons as measured by gel permeation chromatography and a dispersity (Mw/Mn) of 1.2 to 3.5 and (ii) and a chemical blowing agent and/or a cell opening surfactant.

10. The steering wheel of claim 9, wherein the flexible injection molded thermoplastic polyurethane foam has:
(i) a peak temperature of crystallization, as measured by DSC, of 25° C. to 205° C.;
(ii) a peak temperature of melting, as measured by DSC, of 106° C. to 206° C.; and
(iii) a difference between the peak temperature of melting and the peak temperature of crystallization, each as measured by DSC, between 1 and 137° C.

11. The steering wheel of claim 9, wherein the flexible injection molded thermoplastic polyurethane foam has:
(i) a vertical rebound, as measured by ASTM D2632, of at least 30%;
(ii) a compression set at room temperature, as measured by ASTM D395, of no more than 25%;
(iii) a compression set at 50° C., as measured by ASTM D395, of no more than 50%; and
(iv) an Asker C hardness, as measured by ASTM D2240, of 30 to 65.

12. The steering wheel of claim 9, wherein the blowing agent comprises a chemical blowing agent, an exothermic type blowing agent, or an endothermic type blowing agent.

13. (canceled)

14. The steering wheel of claim 12, wherein the exothermic blowing agent comprises azodicarbonamide.

15. (canceled)

16. The steering wheel of claim 12, wherein the endothermic type blowing agent comprises a mixture of sodium bicarbonate and citric acid.

17. The steering wheel of claim 9, wherein the chemical blowing agent is delivered by a masterbatch comprising a polymer carrier and the chemical blowing agent.

18. The steering wheel of claim 17, wherein the flexible thermoplastic polyurethane foam is formed from the combination of 0.5% to 10% by weight of the masterbatch and 90% to 99.5% by weight of the second thermoplastic polyurethane material.

19. The steering wheel of claim 17, wherein the polymer carrier comprises a carrier thermoplastic polyurethane composition, wherein the carrier thermoplastic polyurethane composition may be the same or different from the first thermoplastic polyurethane material and the second thermoplastic polyurethane material.

20. The steering wheel of claim 17, wherein the polymer carrier comprises polyethylene.

21. The steering wheel of claim 9, wherein the cell opening surfactant comprises one or more silicones, siloxane copolymers, non-siloxane co-polymers, non-silicones, or any combination thereof.

22. The steering wheel of claim 1, wherein the second thermoplastic polyurethane material comprises the reaction product of (a) at least one polyol component, (b) at least one diisocyanate component, and (c) at least one chain extender component, wherein the combined weight of the at least one diisocyanate component and the at least one chain extender component make up a hard segment content of the thermoplastic polyurethane material and wherein the thermoplastic polyurethane material has a hard segment content of 20% to 60% by weight.

23-30. (canceled)

31. The steering wheel of claim 1, wherein the steering wheel frame comprises a steering wheel rim, a hub base and at least one spoke, wherein the hub base is arranged inside the steering wheel rim and the hub base is connected to the steering wheel rim by the at least one spoke.

32. A method of making a steering wheel comprising the steps of:
forming a steering wheel frame by injection molding a first thermoplastic polyurethane material having (a) a weight average molecular weight of 50,000 to 350,000 Daltons; (b) a Notched Izod Impact Strength (3.2 mm/23° C.) of 1.5 to 30 ft-lb/in measured according to ASTM D256; (c) a flexural modulus of 80,000 to 2,300,000 measured according to ASTM D790; (d) Instrumented Dart Impact (Total Energy at 23° C.) of 100-900 ln-lb measured according to ASTM D 3763; and (e) Tensile Modulus of 80,000 to 2,600,000 psi measured according to ASTM D638.

33. The method of claim 32, wherein the first thermoplastic polyurethane material comprises the reaction product of a first diisocyanate component, a first chain extender component, and, optionally, at least one first polyol component, wherein the combined weight of the first diisocyanate component and the first chain extender component make up a hard segment content of the first thermo-plastic polyurethane material.

34. The method of claim 33, wherein the first thermoplastic polyurethane material comprises at least 60% by weight hard segment content.

35. (canceled)

36. The method of claim 33, wherein the first diisocyanate component is an aromatic diisocyanate.

37. The method of claim 33, wherein the first diisocyanate component is 4,4′-methylenebis(phenyl isocyanate).

38. The method of claim 33, wherein the first chain extender component is selected from 1,4-butanediol, 1,6-hexanediol, 1,4-cyclohexanedimethanol, nonanediol, dodecanediol, or combinations thereof.

39. The method of claim 33, wherein the first polyol component is present and comprises a polyether polyol or a polyester polyol.

40. (canceled)

41. The method of claim 32, comprising forming a foam cover for the steering wheel frame via the additional steps of
(1) providing a thermoplastic polyurethane foaming mixture comprising a second thermoplastic polyurethane material and a chemical blowing agent, wherein the second thermoplastic polyurethane material comprises the reaction product of (i) at least one polyol component, (ii) at least one diisocyanate component, and (iii) at least one chain extender component, and wherein the thermoplastic polyurethane (a) has a hard segment content of 20% to 60% by weight, (b) a weight average molecular weight of 50,000 to 350,000 Daltons as measured by gel permeation chromatography, and (c) a dispersity (Mw/Mn) of 1.2 to 3.5;
(2) mixing the second thermoplastic polyurethane material and the chemical blowing agent, resulting in a foaming mixture;
(3) injection molding the foaming mixture in such a way that the second thermoplastic polyurethane material and the chemical blowing agent surfactant interact to form a flexible injection molded thermoplastic polyurethane foam.

42. The method of claim 41, wherein the flexible thermoplastic polyurethane foam has:
(i) a peak temperature of crystallization, as measured by DSC, of 25° C. to 205° C.;
(ii) a peak temperature of melting, as measured by DSC, of 106° C. to 206° C.; and
(iii) a difference between the peak temperature of melting and the peak temperature of crystallization, each as measured by DSC, between 1 degree and 137 degrees.

43. The method of claim 41, wherein the flexible injection molded thermoplastic polyurethane foam has:
(i) a vertical rebound, as measured by ASTM D2632, of at least 30%;
(ii) a compression set at room temperature, as measured by ASTM D395, of no more than 25%;
(iii) a compression set at 50° C., as measured by ASTM D395, of no more than 50%; and
(iv) an Asker C hardness, as measured by ASTM D2240, of 30 to 65.

44. The method of claim 41, wherein the chemical blowing agent comprises an exothermic type blowing agent or an endothermic type blowing agent.

45. The method of claim 44, wherein the exothermic blowing agent comprises azodicarbonamide.

46. (canceled)

47. The method of claim 44, wherein the endothermic type blowing agent comprises or consists of a mixture of sodium bicarbonate and citric acid.

48. The method of claim 41, wherein the chemical blowing agent is delivered by a masterbatch comprising a polymer carrier and the chemical blowing agent.

49. The method of claim 48, wherein the foaming mixture contains 0.5% to 10% by weight of the masterbatch and 90% to 99.5% by weight of the second thermoplastic polyurethane material.

50. The method of claim 46, wherein the polymer carrier comprises a carrier thermoplastic polyurethane composition.

51. The method of claim 46, wherein the polymer carrier comprises polyethylene.

52-59. (canceled)

60. The method of claim 32, wherein the steering wheel frame comprises a steering wheel rim, a hub base and at least one spoke, wherein the hub base is arranged inside the steering wheel rim and the hub base is connected to the steering wheel rim by the at least one spoke.

61. The method of any claim 41, wherein the step of injection molding the foaming mixture takes place in a closed mold.

62. The method of any claim 41, wherein the step of injection molding the foaming mixture includes directly molding the foam cover to the steering wheel frame.
